(19) United States
(12) Patent Application Publication
(10) Pub. No.: US 2017/0001606 A1
(43) Pub. Date: Jan. 5, 2017

(54) Actuation Device for a Parking Brake

(71) Applicant: Power-Cast Light Metal Solutions GmbH & Co. KG, Schlierbach (DE)

(72) Inventor: Wolfgang Kaltenmaier, Gruibingen (DE)

(21) Appl. No.: 15/115,291

(22) PCT Filed: Jan. 30, 2015
(86) PCT No.: PCT/EP2015/051877

§ 371 Date: Jul. 29, 2016

(30) Foreign Application Priority Data
Feb. 21, 2014 (DE) 20 2014 100 778.4

(51) Int. Cl. B60T 7/10

(52) U.S. Cl. CPC B60T 7/105

(57) ABSTRACT

The invention relates to an actuation device (1) for a parking brake and comprises a parking brake lever (2) which is pivotally connected to a bearing block (3), a handle (12) being provided on the free end of said lever. The parking brake lever (2) can be held in place on the bearing block (3) in a pivoted position, using a locking device. The handle (12) forms an actuation element by means of which the held in place position of the parking brake lever (2) on the bearing block (3) can be released.

### CROSS REFERENCE TO RELATED APPLICATIONS

This application is the U.S. national stage of International Application No. PCT/EP2015/051877, filed on Jan. 30, 2015. The international application claims the priority of DE 202014100778.4 filed on Feb. 21, 2014; all applications are incorporated by reference herein in their entirety.

### BACKGROUND

The invention relates to an actuation device for a parking brake in accordance with the preamble of claim 1.

An actuation device of that type is known from DE 10 2005 013 475 A1, for instance. This actuation device is comprised of a parking brake lever swivel-mounted on a bearing block, a blocking device that has a locking segment fixed in place on the bearing block and a movably mounted pawl, and an actuation rod in the parking brake lever that can be actuated against the spring force of a spring when a button is pressed. The actuation rod has a land for coupling to the pawl; in a latched position of the pawl, it is fixed in place on the locking segment by means of the spring force of a catch spring and the land is seated on a segment of the edge of the pawl turned towards the locking segment. When the actuation rod is actuated, a force acting against the spring force of the catch spring, via which the pawl is released from the locking segment, is exerted by the land on the pawl by means of the button.

A drawback of this actuation device is, as is the case with corresponding known actuation devices of this type, that the movement of the actuation rod has to be converted into a swivel movement of the pawl. The pawl is generally mounted on a pivot bearing so as to be able to swivel for this. Additional parts are required in general to provide this pivot bearing, which involves undesired costs. These costs are increased even further because the additional parts of this pivot bearing have to be assembled and mounted on the parking brake lever. The button provided at the front end of the parking brake lever and its coupling to the actuation rod also require considerable construction expenses.

### SUMMARY

The invention relates to an actuation device (1) for a parking brake and comprises a parking brake lever (2) swivel-mounted on a bearing block (3) that is provided with a handle (12) at its free end. The parking brake lever (2) can be fixed in place in a swivel position on the bearing block (3) with a blocking device. The handle (12) forms an actuation element via which the fixed position of the parking brake lever (2) on the bearing block (3) can be released.

### DETAILED DESCRIPTION

The invention is based on the objective of providing an actuation device of the type mentioned at the outset that has a high level of functionality with reduced construction expenses.

The elements of claim 1 are specified to solve this problem. Advantageous embodiments and useful design developments of the invention are described in the sub-claims.

The invention relates to an actuation device for a parking brake and comprises a parking brake lever swivel-mounted on a bearing block that is provided with a handle at its free end. The parking brake lever can be fixed in place in a swivel position on the bearing block with a blocking device. The handle forms an actuation element via which the fixed position of the parking brake lever on the bearing block can be released.

The basic idea of the invention is consequently to release the blocking device of the actuation device via actuation, meaning a movement of the handle on the parking brake lever. The concept of known actuation devices that has been exclusively used up to now, releasing the blocking device by pressing a button on the front end of the parking brake lever so that the parking brake can be operated, is therefore relinquished.

The construction expenses can, surprisingly, be significantly reduced because of that without having to accept losses in functionality or operating comfort of the actuation device for this.

The actuation device as per the invention advantageously has, as a blocking device, in accordance with known actuation devices of this type, a fixed locking segment with toothing and a pawl that is movably mounted with respect to it; the parking brake lever is fixed in place when the pawl engages in the toothing of the locking segment.

An important aspect of the invention is that the movement of the handle can be transferred in a simple way to the pawl, so the construction resources for the movable mounting of the pawl can be substantially simplified in general; the construction expenses for the overall actuation device can be considerably reduced because of that.

In accordance with an especially advantageous embodiment of the invention, the blocking device is released via a linear movement of the handle on the parking brake lever.

In so doing, the linear movement of the handle is converted into a linear movement of the pawl.

The linear movement of the handle is advantageously converted into a linear movement of the pawl without redirection means here.

Because of this direct conversion of the linear movement of the handle to a linear movement of the pawl, separate parts for a pivot bearing of the pawl can be omitted; a substantial reduction in the number of parts of the actuation device and correspondingly simplified assembly of the overall actuation device result because of that.

It is especially advantageous when the parking brake lever includes a coupling unit that transfers the linear movement of the handle to the pawl.

In particular, the coupling unit is a rod, a cable or a Bowden cable.

A major advantage of the invention is that a single coupling unit is sufficient to transfer the linear movement of the handle to the pawl. This also leads to a reduction in the number of parts of the actuation device and a corresponding reduction in assembly time of the actuation device.

The handle on the parking brake lever is pushed backwards or pulled forwards to actuate the blocking device depending on the design of the coupling unit.

Since, in contrast to the known actuation devices, the pawl is no longer moved towards, or moved away from, the locking segment with a swivel movement, but instead with a linear movement as per the invention, a further advantage results in that the pawl is no longer just able to have one ratchet tooth, but can instead have several ratchet teeth that can engage with the toothing of the locking segment. The hold of the pawl on the locking segment in its latched position is substantially improved because of that.

In an alternative design form of the invention, the blocking device is released via a rotational movement of the handle. In this case, the handle is rotated to release the blocking device. The rotational movement of the handle is then converted via a coupling unit into a movement, especially a linear movement, of the pawl.

### BRIEF DESCRIPTION OF THE DRAWINGS

The invention will be explained with the aid of the drawings below. The following are shown in the figures:

FIG. 1: Components of a first embodiment of the actuation device as per the invention.

FIG. 2: Parking brake lever with a handle mounted on it included in the actuation device in accordance with FIG. 1.

FIG. 3: Components of a second embodiment of the actuation device as per the invention.

### DETAILED DESCRIPTION OF THE PREFERRED EMBODIMENTS

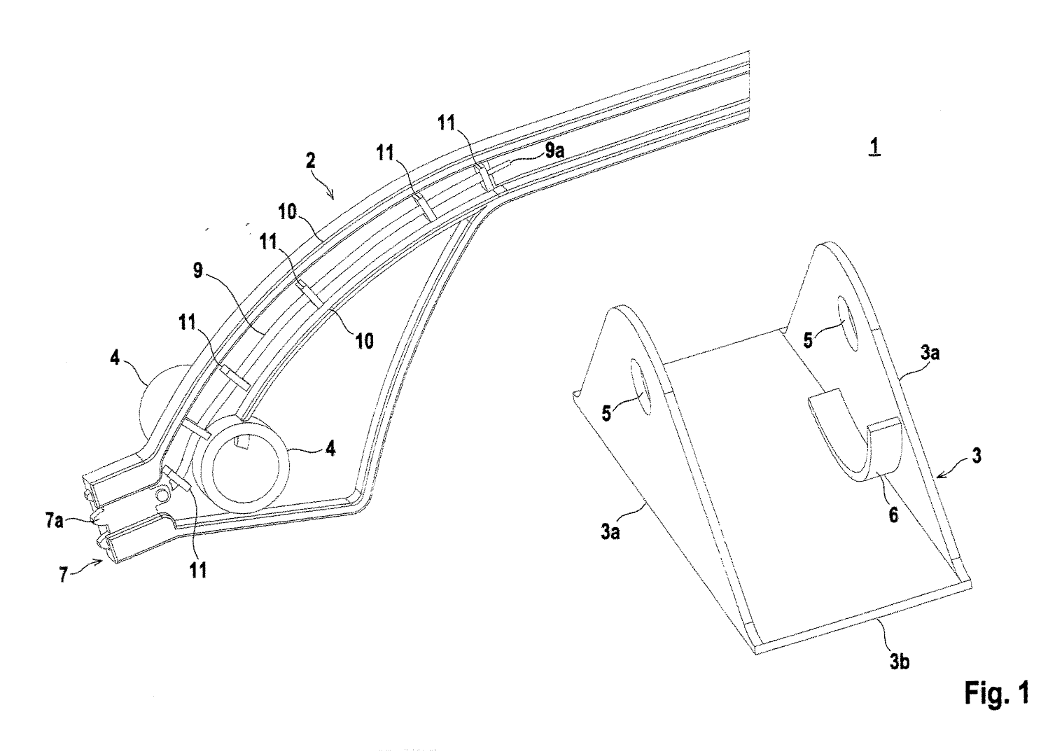

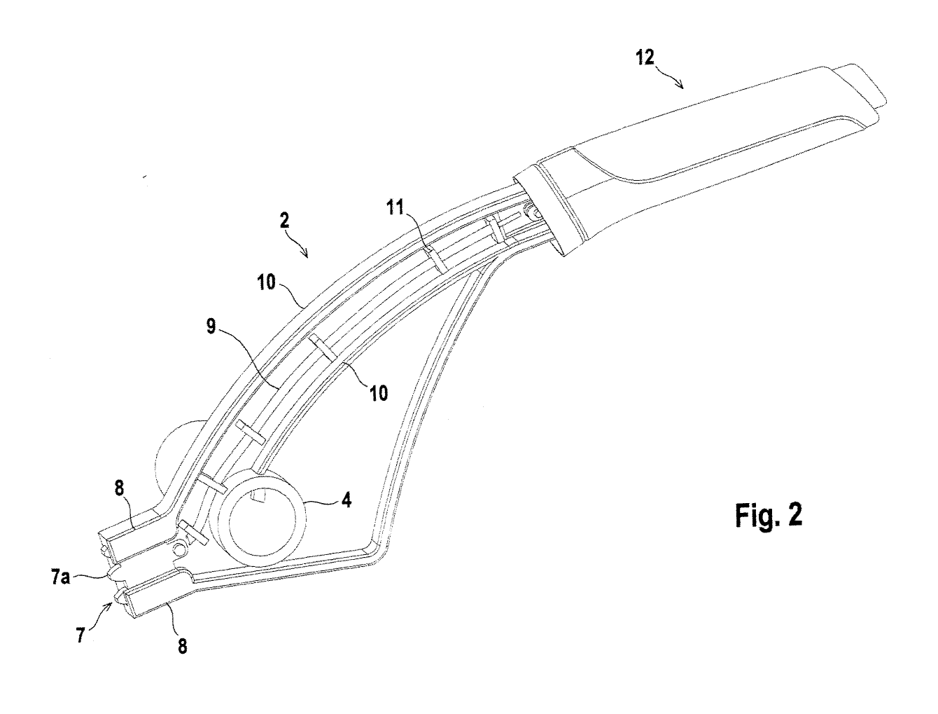

FIGS. 1 and 2 show the essential components of a first example of the actuation device 1 as per the invention for a parking brake of a motor vehicle. As shown in FIG. 1, the actuation device 1 has a parking brake lever 2 and a bearing block 3. The parking brake lever 2 has a tube-shaped receptacle 4 associated with two holes 5 in the bearing block 3; one hole 5 is arranged in each case in a flank 3a of the bearing block 3. These flanks 3a run in parallel at a distance to one another and end in each case at a right angle to the base piece 3b of the bearing block 3. The parking brake lever 2 can be swiveled on the bearing block 3 around a horizontal axis via a shaft or the like, which is not shown, that is inserted into the tube-shaped receptacle 4 of the parking brake lever 2 and into the holes 5 of the bearing block 3.

The respective swivel position of the parking brake lever 2 is transferred via a pull rod or the like, which is not shown, to the parking brake, likewise not shown, of the motor vehicle in which the actuation device 1 is installed.

A blocking device is provided to fix the parking brake lever 2 in place in a specified swivel position. This blocking device is comprised of a locking segment 6, having toothing with an arrangement of teeth in a known way, that is mounted on the bearing block 3 and firmly connected to it. A pawl 7 is provided on the parking brake lever 2 as a further component of the blocking device. This pawl 7 is movably mounted on opposite sides in in the longitudinal direction of accommodation grooves 8 of the parking brake lever 2. The pawl 7 has three ratchet teeth 7a at its end projecting over the accommodation grooves 8 that are adapted in terms of their geometries to the teeth of the locking segment 6, so they can engage there.

When the parking brake lever 2 is mounted on the bearing block 3, a swivel position of the parking brake lever 2 is fixed in place by the pawl 7 being pressed against the locking segment 6 with a contact pressure that is generated, for instance, by a spring element, which is not shown, acting on the pawl 7 so that the ratchet teeth 7a of the pawl 7 firmly engage in the toothing.

To release the pawl 7 from the locking segment 6, a Bowden cable 9 is coupled as a coupling unit to the end of the pawl 7 opposite the ratchet teeth 7a. The Bowden cable 9 runs in a guide exposed on the side of the parking brake lever 2 that has lateral boundaries in the form of two rail segments 10 that are designed along with the parking brake lever 2 to form one piece. Guide elements 11, likewise designed in one piece, surround the Bowden cable 9 in a clamp-like fashion between the rail segments 10, so the Bowden cable is routed in the guide elements 11 with very little play. The free end 9a of the Bowden cable 9 that can be seen in FIG. 1 is coupled to a handle 12 that is mounted on the rod-shaped front end of the parking brake lever 2. The handle 12 is movably mounted in the longitudinal direction of the front end of the parking brake lever 2 here, meaning the handle 12 can carry out linear movement on the parking brake lever 2.

To release the pawl 7 from the locking segment 6, the handle 12 is pulled forward on the parking brake lever 2 by an operator. This linear movement is transferred via the Bowden cable 9 as a coupling unit, directly and without redirection means, to the pawl 7, so the pawl 7 likewise carries out a linear movement and is pulled away from the locking segment 6 with this linear movement. The parking brake lever 2 can therefore be swiveled on the bearing block 3. Once the operator has swiveled the parking brake lever 2 into the desired position, he will let go of the handle 12, and the pawl 7 will automatically engage in the locking segment 6 and thereby secure the desired swivel position of the parking brake lever 2.

A button is consequently no longer required as a separate element for actuating the blocking device in the actuation device 1 as per the invention. Accordingly, a button is no longer provided at the front end of the parking brake lever 2 in the embodiment in accordance with FIG. 1. In principle, a button of that type could still be provided as a design element, though.

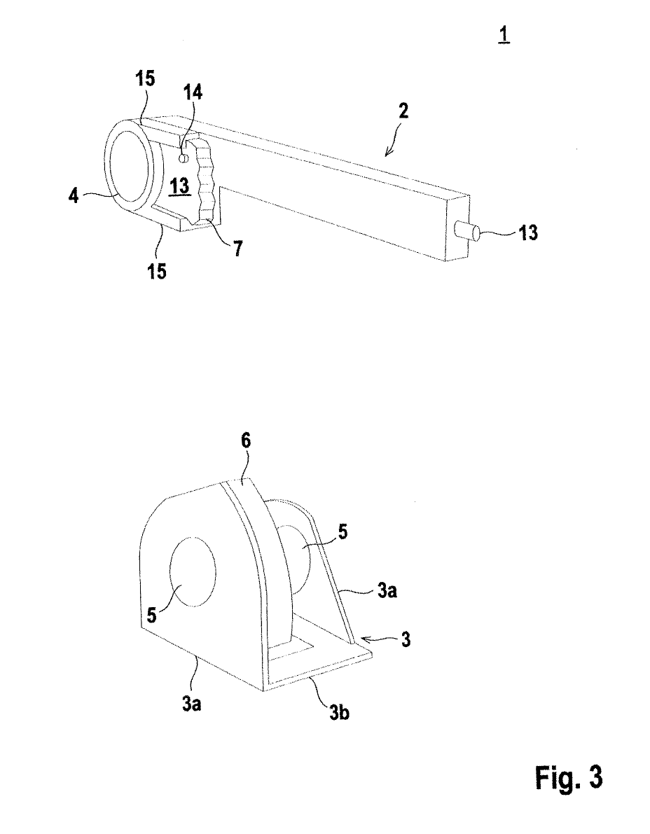

FIG. 3 shows a second example of the actuation device 1 as per the invention. This actuation device 1 is also comprised of a bearing block 3 and a parking brake lever 2, shown in a partial diagram in FIG. 3, that is swivel-mounted on it. Analogously to the embodiment in accordance with FIGS. 1 and 2, the bearing block 3 is comprised once again of a base piece 3b with two flanks 3a ending perpendicularly on it. The parking brake lever 2 has a tube-shaped receptacle 4 and the bearing block 3 has two holes 5, into which a shaft or the like, not shown, can be inserted, to form the pivot bearing of the parking brake lever 2 on the bearing block 3.

The blocking device of the actuation device 1 is comprised once again of a locking segment 6 with toothing that is firmly connected to the bearing block 3 and a pawl 7 with several ratchet teeth 7a that is mounted on the parking brake lever 2.

A swivel position of the parking brake lever 2 on the bearing block 3 is once again fixed in place by the pawl 7 being held with contact pressure against the locking segment 6 s that the ratchet teeth 7a of the pawl 7 engage on the locking segment 6.

To be able to release the pawl 7 from the locking segment 6, a rod 13 is movably mounted in the axial direction in this case as a coupling unit in the parking brake lever 2. A catch 14 that couples the rod to the pawl 7 is provided at the end of the rod that is turned towards the pawl 7. The opposite end of the rod 13 is coupled to a handle 12, not shown in FIG. 2, that is put on the parking brake lever 2 and movably mounted on it in its longitudinal direction, meaning the handle 12 can carry out a linear movement on the parking brake lever 2.

To release the pawl 7 from the locking segment 6, the handle 12 is pulled backwards on the parking brake lever 2 in this case. The rod 13 is moved in the same direction because of that. This movement is transferred by the catch 14 to the pawl 7 so that it is pulled away from the locking segment 6 and the ratchet teeth 7a of the pawl 7 are therefore no longer engaged with the teeth of the locking segment 6. The pawl is held in guides 15 that are components of the parking brake lever 2 so that the pawl 7 carries out an exact linear movement. After the pawl 7 is released from the locking segment 6, the parking brake lever 2 can be swiveled into the desired position. Once the desired position is reached, the operator will let go of the handle 12, and the pawl 7 will automatically engage with its ratchet teeth 7a in the teeth of the locking segment 6.

The parking brake can be released by putting the parking brake lever 2 into a swivel position constituting a neutral position. The parking brake can be tightened, meaning actuated, by swiveling the parking brake lever 2 into a swivel position that is preferably above the neutral position.

### LIST OF REFERENCE NUMERALS

(1) Actuation device

(2) Parking brake lever

(3) Bearing block

(3a) Flank

(3b) Base piece

(4) Receptacle

(5) Hole

(6) Locking segment

(7) Pawl

(7a) Ratchet teeth

(8) Accommodation groove

(9) Bowden cable

(9a) Free end

(10) Rail segment

(11) Guide element

(12) Handle

(13) Rod

(14) Catch

1. Actuation device (1) for a parking brake with a parking brake lever (2) swivel-mounted on a bearing block (3) with a handle (12) provided on the free end of said parking brake lever and with a blocking device via which the parking brake lever (2) can be fixed in place in a swivel position on the bearing block (3), characterized in that the handle (12) comprises an actuation element via which the fixed position of the parking brake lever (2) on the bearing block (3) can be released.

2. Actuation device according to claim 1, characterized in that the blocking device is released via linear movement or rotational movement of the handle (12) on the parking brake lever (2).

3. Actuation device according to claim 1, characterized in that the blocking device has a fixed locking segment (6) with toothing and a pawl (7) movably mounted on said locking segment, wherein the parking brake lever is fixed in place via the engagement of the pawl in the toothing of the locking segment (6).

4. Actuation device according to claim 1, characterized in that the linear movement or rotational movement of the handle (12) is converted into a linear movement of the pawl (7).

5. Actuation device according to claim 4, characterized in that the linear movement of the handle (12) is converted into a linear movement of the pawl (7) without redirection means.

6. Actuation device according to claim 4, characterized in that the handle (12) on the parking brake lever (2) is rotated, pressed backwards or pulled forward to actuate the blocking device.

7. Actuation device according to claim 4, characterized in that there is a coupling unit in the parking brake lever (2) that transfers the linear movement or rotational movement of the handle (12) to the pawl (7).

8. Actuation device according to claim 7, characterized in that the coupling unit is a rod, a cable or a Bowden cable (9).

9. Actuation device according to claim 4, characterized in that the pawl (7) has several ratchet teeth (7a) that can be engaged with the toothing of the locking segment (6).
